(19) United States
(12) Patent Application Publication
(10) Pub. No.: US 2006/0004769 A1
(43) Pub. Date: Jan. 5, 2006

(54) Method for distributing software and services

(76) Inventor: Michael Fleming, San Dimas, CA (US)

Correspondence Address: NATH & ASSOCIATES, 1030 15th STREET, NW, 6TH FLOOR, WASHINGTON, DC, 20005, US

(21) Appl. No.: 11/143,121

(22) Filed: Jun. 1, 2005

Related U.S. Application Data
(60) Provisional application No. 60/575,414, filed on Jun. 1, 2004.

(51) Int. Cl. G06F 17/30

(52) U.S. Cl. 707/10

(57) ABSTRACT

A service company establishes tools including communications templates to provide for establishment of relationships with individuals by a client organization and a website for use by the client organization. Individuals may select the frequency of e-mail provided to them by the client organization and select from a range of content options. The client organization continues to send periodic communications as authorized by the individual including content correlating to selections by the individual that does not mention the client organization. Communication thus indicates that the individual is valued apart from his or her potential contributions. The e-mails include website links selected by the client organization. In a further form, the service company works with a key umbrella organization that has an affiliation with a plurality of client organizations. The service company provides a grant to the key umbrella organization. The key umbrella organization develops a plan to cause client organization to begin using tools from the service company. The grant is made by the service company to fund efforts of the key umbrella organization.

### FIELD OF THE INVENTION

The present invention relates to a method of distributing software and to a method for providing services utilizing the software.

### BACKGROUND OF THE INVENTION

One sector of users employing software to provide Internet services is the non-profit market. Nonprofit organizations operate differently from most companies. Challenges facing nonprofit organizations in developing a contributor base have been addressed by providing them with tools including, for example, software and website templates. In one prior system, the service company provides tools that coordinate and motivate volunteers and empower volunteers with valuable data and content that enables more targeted and effective donor solicitations from individuals. The tools include software that organizes data gathered in the donor cultivation and fundraising processes, disseminates this data throughout the client organization and simplifies important activities such as making donations and processing payments. This software is built on a unified database and comprehensive payment processing system to provide client organizations with scalable, reliable and secure services. The client organization accesses the software tool through a web browser and pays for access to the software through a combination of upfront and monthly service fees and transaction-based fees under contracts that are typically more than one year in duration.

Communication has in the past been provided as indicated at www.eprayerconnect.org. This communication includes storytelling focused on the organization communicating with the individual.

U.S. Pat. No. 6,519,629 is entitled System For Creating A Community For Users With Common Interests To Interact In. However, with regard to fundraising, this patent refers to providing news of fundraising efforts and news of collections rather than interactive methods.

A shortcoming of the prior art is that there has not been an emphasis on elements of communication including relationship building and storytelling unrelated to the nonprofit organization and focusing on needs of the recipient of the communication.

Software is generally distributed through conventional channels. Many service companies utilize direct marketing, sales representatives and wholesalers who supply to retail outlets. While these relationships have a proven track record as sales techniques, they do not create a relationship in which the service organization is able to direct activities of the sales organization to achieve further market penetration.

### SUMMARY OF THE INVENTION

In accordance with an aspect of the invention, there is provided a method of distributing relationship tools by a service company through at least one key umbrella organization, each said key umbrella organization having an affiliation with at least one client organization, said method comprising: providing relationship software operated by the service company, the relationship software establishing relationships between subscribers and a client organization; enrolling client organizations to each have the relationship software operated on its behalf; enrolling the client organizations by a key umbrella organization; and providing a grant from the service company to the key umbrella organization to fund incorporation of the abilities of the service company into the vision of the key umbrella organization and its client organizations.

In accordance with a further aspect of the invention, there is provided a method of utilizing relationship software comprising: providing hosted content accessible by individuals; communicating to individuals and providing links to the hosted content; enabling an individual to select in response options including a frequency of communication for further communication and at least one content option including content to indicate an interest of the individual; and further communicating repeatedly with the individual in accordance with the options selected by the individual and including in the communication content to address the indicated interest that does not include promotional material.

While this Summary of the Invention section lists various aspects of varying embodiments of the present invention, there are other aspects of the present invention, or preferred embodiments thereof, apparent from the following description. This Summary is neither exhaustive nor intended to be determinative of the scope of the invention.

### BRIEF DESCRIPTION OF THE DRAWINGS

The invention may be further understood by reference to the following description taken in connection with the following drawings.

Of the drawings:

FIG. 1 is an illustration of an application in which embodiments of the present invention are utilized;

FIG. 2 is a flow chart illustrating a method in accordance with an embodiment of the present invention;

FIG. 3 is an illustration of an application in which a further embodiment of the present invention may be used; and

FIG. 4 is an illustration of a further method in accordance with an embodiment of the present invention.

### DETAILED DESCRIPTION

Definitions: For purposes of the present description, a nonprofit organization is characterized as a client organization. An entity providing tools is referred to as a service company. The audience of the client organization is referred to as individuals. Individuals may comprise one person at a time, or individuals may be comprised in a family or group. Individuals are persons that are addressed, generally with the objective that some percentage of them will become part of a contributor base. A key umbrella organization is an organization having a unifying vision that is embraced by a plurality of client organization members. Key umbrella organizations may exist at different levels where there is multi-tiered relationship among affiliated organizations.

Embodiments of the present invention provide for establishment of relationships with individuals beyond the gathering of demographic data and provide in a further form for a relationship of a service company with a key organization in order to promote the use of tools by client organizations.

In one preferred form, the service company establishes a website template for use by a client organization. The client organization may customize the template within a range of parameters set by the service company. The client organization will commonly customize its own site with its own identity. The client organization utilizes its own list of addresses. The service company designs the websites so that individuals accessing a site hosted on behalf of a client organization may select the frequency of e-mail provided to them by the client organization. The individual also selects content to be provided from a range of options. The client organization continues to send periodic communications as authorized by the individual. The communications include, for example, system-supplied “story” content that does not mention the client organization. It is a communication directed to meeting a need indicated by the individual through the selection of content and not to direct promotion of the client organization. The e-mails to the individual may also include links to websites selected by the client organization. The client organization also selects depths of available further links so that individuals may “drill down” to further depths to access further web pages.

Embodiments of the present invention provide the ability to create processes that deal with life issues that are important to the individual. The individual is provided with customized content in communications. Also, for links which the individual accesses, the server may remember what the individual accessed in a previous session and provide next information in a sequence.

The system allows individuals to create private lists to which the client organization does not have access. The individual may communicate to family or friend. The individual may create prayer teams.

Encouragement and processing of contributions is done separately from the establishing of relationships with the individuals.

In a further form, the service company works with an entity referred to for purposes of the present description as a key umbrella organization. The entity is an organization that has an affiliation with a plurality of client organization. One form of a key umbrella organization is a headquarters of a religious denomination. In this embodiment, the client organizations would be individual churches within that denomination. In another embodiment, the key umbrella organization is a non-profit trade association. In this embodiment, the client organizations would be individual non-profit member organizations within that association. In these embodiments, the service company provides a grant to the key umbrella organization. The key umbrella organization develops a plan to cause client organization to begin using tools from the service company. The grant is made by the service company to fund efforts of the key umbrella organization. The service company may additionally work with traditional resellers.

Embodiments of the present invention may be utilized in connection with political parties as well as religious organizations and trade associations. Application may also be found with respect to commercial organizations.

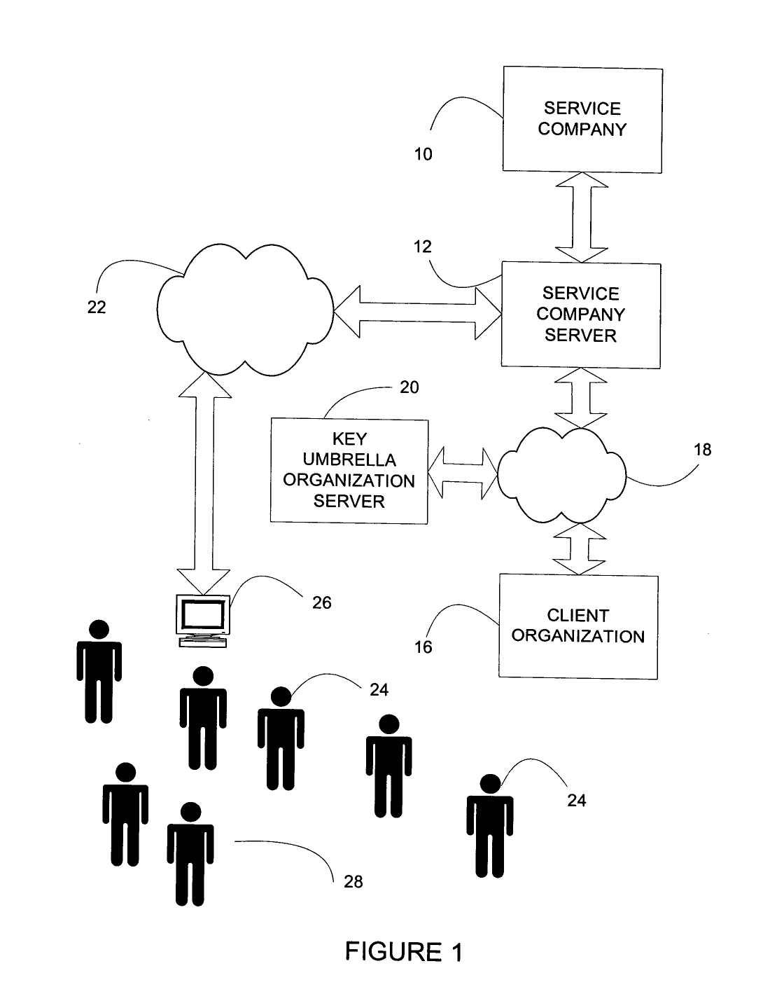

FIG. 1 is an illustration of an application for embodiments of the present invention. While various entities may be the proprietor of methods according to embodiments of the present invention, the methods will commonly be practiced by a service company 10. The service company 10 will provide tools for use by or on behalf of a client organization 16. The client organization in many embodiments will be a non-profit organization. One type of nonprofit organization with which embodiments of the present invention are particularly suited is religious organizations. Alternatively, a client organization 16 could be a political party. While embodiments of the present invention are particularly suited to the needs of nonprofit organizations, the client organization 16 need not necessarily be nonprofit.

The client organization communicates with individuals 24. Individuals may comprise one person at a time, or individuals may be comprised in a family or group. Individuals 24 are persons that are addressed so that the client organization 16 may develop a relationship with them. Initially, the client organization will give individual 24 the opportunity to become subscribers. Being a subscriber may take a number of forms. It generally relates to establishing a connection with the individual 24 short of having the individual 24 become a contributor. The individual 24 may, for example, request that the client organization 16 send e-mail to the individual 24. The individual 24 will have the opportunity to become part of a contributor base sometime thereafter.

In one preferred form, the service company 10 provides tools for the client organization 16 on a server 12. In FIG. 1, a network connection between the service company 10 and the server 12 is illustrated, but Internet connection could be provided as well. The client organization 16 may connect to a service company server 12 or to a key umbrella organization server 20. The client organization 16 may also connect to the server 12 via the server 20.

One tool comprises an e-mail utility through which the service organization can send e-mails to individuals 24. The client organization in a preferred form provides addresses for the mailing population. Another utility allows the selection of content to be provided in the e-mail from a menu. Another tool is a set of website templates. The use of website templates is well known in the art. Templates are routinely provided by web hosting companies. The service company 10, or other organization, provides a number of web pages. The client organization 16 can select which pages it wants to include in its website. Additionally, the website template may be customized to allow the client organization 16 to insert its own identification and contact information.

In order to select its content and to interact with the server 12, the client organization 16 accesses the server 12, generally through an Internet connection 18. The client organization 16 accesses an account with the service company 10 at the server 12 through a conventional sign-in process. The client organization 16 establishes a website. The client organization 16 also establishes an e-mail list. An initial e-mail includes information and links to the website. Individuals 24 can access the website via an Internet connection 22. Individuals 24 will use an interface device 26 which may comprise a computer, personal digital assistant or other device providing Internet access.

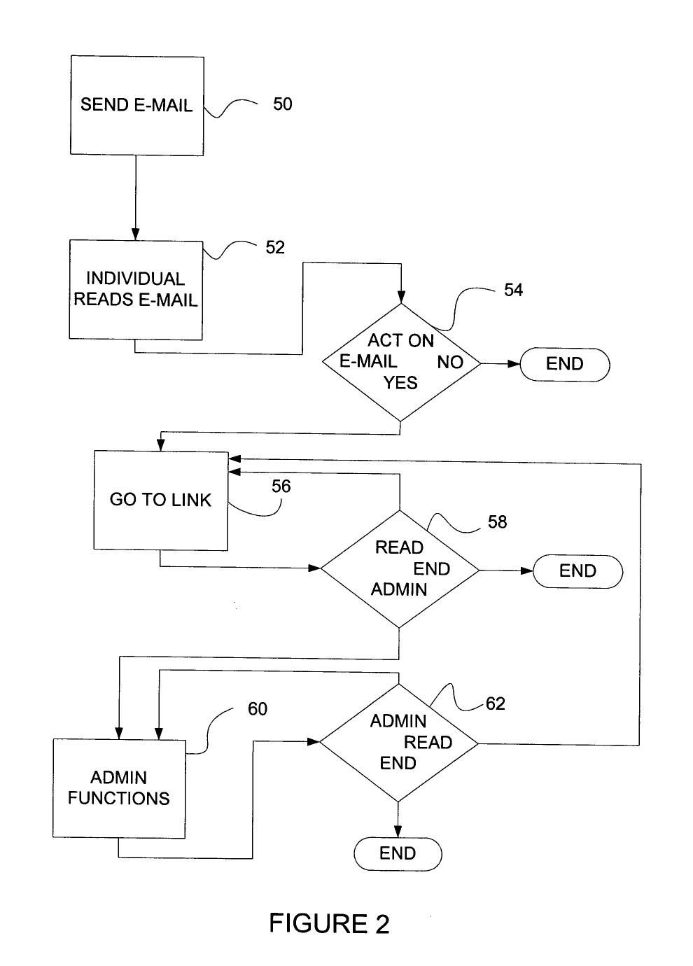

The mailing is the beginning of an interaction further illustrated in FIG. 2, which is a flow chart. At a block 50, the client organization 16 contacts an individual 24 or many individuals 24, for example by e-mail. The individual 24 reads the e-mail at block 52 and decides as block 54 what further action to take. The individual 24 can take no action, and the process ends. Alternatively, action can be taken. Typically, this will be accessing a link in the e-mail which takes the individual 24 to a website of the client organization 16. The individual 24 reads the web page at block 56. At block 58, the individual 24 can elect to exit from the web site or can return to additional content. The individual 24 can also branch to block 60 to perform administrative functions.

Available administrative functions will generally be those specified in a web page template provided by the service company 10 and selected by the client organization 16. Administrative functions may include subscribing to a mailing list maintained by the client organization 16. Future mailings will be initiated at future dates, and the process will return to block 50. In subscribing to the mailing list, the individual 24 may select among content options. The individual 24 may also update subscription information. Administrative functions may also include creating communications to others 28, such as friends or family. A group of “others” may include one or more people or addresses. The tools permit this function without informing the client organization 16 of identities of correspondents of the individual 24. In this manner, the individual 24 is not discouraged from sharing communications from the client organization 16. After performing administrative functions, operation proceeds to block 62 where the individual 24 may choose to exit, to return to further reading of content or further administrative functions.

Additionally, administrative functions may include the furnishing of contributions from the individual 24 to the client organization 16. However, the individual 24 sees this as a collateral function. Contribution is not a prerequisite for continuing to supply the individual 24 with requested content. Contribution is not required for the individual 24 to create additional communications with further people. The system allows the continuation of further mailings to initiate further operations beginning at block 50 at subsequent times.

The subsequent communications will include content correlating to the content selected by the individual 24 when subscribing to the e-mail list. Such content will include material not to identify or promote the client organization 16 but to meet a need indicated by the by the individual 24's content selection. Thus the service company 10 furnishes content unconditionally to a subscriber to meet a need indicated by the individual 24 indicated by the content selection. This content is not presented to promote directly the interests of the client organization 16. Furnishing of selected content will communicate that the individual 24 is valued apart from his or her potential contributions. Contribution may flow after the relationship valuing the individual 24 is established.

Embodiments of the present invention provide the ability to create processes that deal with life issues that are important to the individual. The individual is provided with customized content in communications. Also, for links which the individual accesses, the server may remember what the individual accessed in a previous session and provide next information in a sequence. The memory may be accomplished by associating a memory space with a username of an individual 24. Alternatively, the server may provide a “cookie” to the individual's computer.

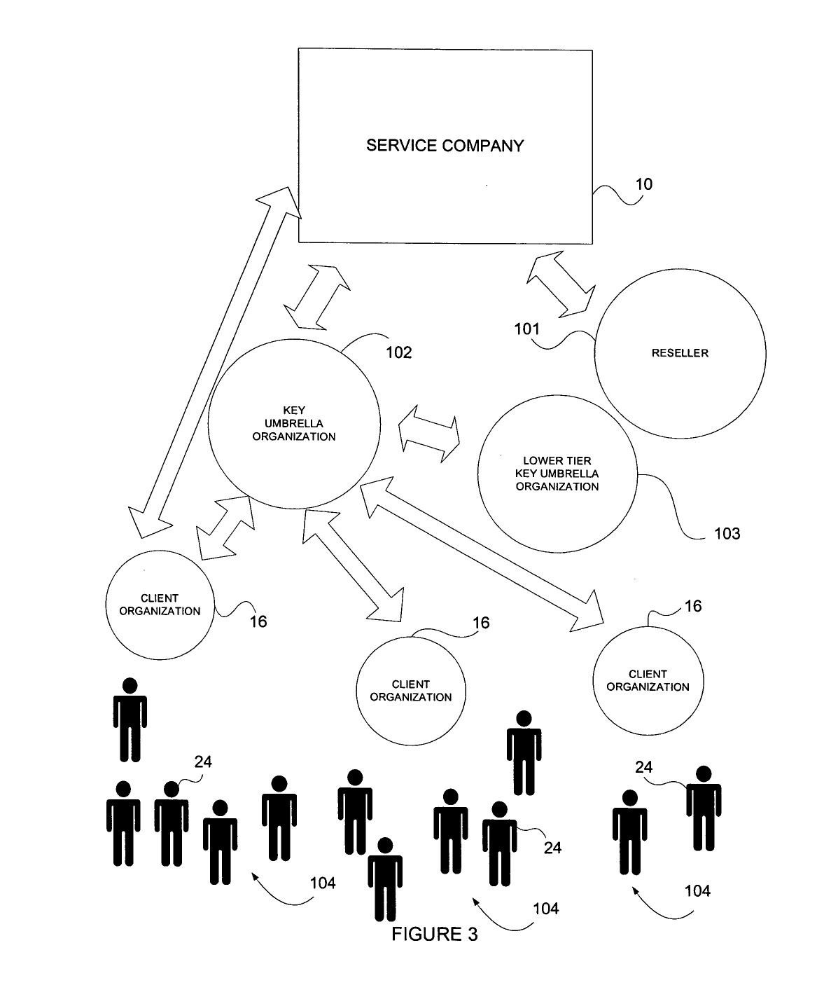

FIG. 3 illustrates a scenario for practice of further embodiments of the present invention regarding distribution of the tools provided by the service company 10. In FIG. 3, the same reference numerals are used to denote elements corresponding to those in FIG. 1. The client organizations 16 may communicate directly with the service organization 10. The service company 10 may work with a reseller 101 in a conventional manner. For example, a reseller 101 may be furnished licenses in the tools at a wholesale rate. The reseller 101 may include a markup in its price of sublicenses furnished to client organizations 16. In a preferred form, the reseller 101 has an affiliation with the key umbrella organization 102.

In accordance with embodiments of the present invention, the service company 10 may work with an entity referred to for purposes of the present description as a key umbrella organization 102. The key umbrella organization 102 is an organization that has a formal affiliation or an affinity with a plurality of client organizations 16. In addition, the key umbrella organization 102 may be affiliated with one ore more lower tier key umbrella organizations 103. The key umbrella organization 103 may interact similarly with its own client organizations. The key umbrella organization 102 could be a headquarters of an association of associations or a religious denomination. In this embodiment, the client organizations 16 would be individual churches within that denomination. In many applications, the key umbrella organization 102 will be associated with thousands of client organizations 16. The key umbrella organization 102 could comprise many forms of nonprofit organizations that will readily suggest themselves to those skilled in the art. There are organizations devoted to research for the cure of diseases, support for suffers of a particular disease or group of disease or alleviation of hardships due to poverty.

While the business model of the method of FIG. 2 is particularly suited to the needs and mission of nonprofit charitable organizations, there are many alternatives. The key umbrella organization 102 may be a political party, and the client organizations 16 may be local clubs. For-profit organizations could also utilize embodiments of the present invention.

Each client organization 16 is associated with a group 104 of individuals 24. The membership of an individual 24 in a group 104 may be defined in many ways. An individual 24 may have a formal membership in a client organization 16. Alternatively, the individual 24 may have a de facto membership in a group 104 by the act of accessing the website of the client organization 16. The service company 10 will generally derive revenue as a function of the number of client organizations 16 employing the tools provided by the service company 10.

Many different revenue models exist. A common revenue model is for the service company 10 to charge by the number of communications issued by the client organization 16 in execution of methods in accordance with the example of FIG. 2 above. In a preferred form, a client organization is charged by the number of individuals 24 that it addresses and not by the number of communications it sends. Since the above method is directed to relationship building, and steady communication is an element of relationship building, it is not desirable to have a cost structure that could discourage client organizations from providing a maximum amount of communication that an individual 24 desires to receive. By increasing the number of client organizations 16 using the tools, the number of individuals 24 to whom communications are made is increased. This will increase revenue to the service company 10 in accordance with the preferred revenue model.

The key umbrella organization 102 commonly will not have the same organization or business model as a reseller 101. For example, resellers 101 may commonly use commissioned salespeople. This is generally undesirable for nonprofits. Nonprofit key umbrella organizations 102 generally do not have the same business model as commercial wholesalers in the regard that commercial wholesalers may make a significant investment in software tools prior to receiving a return on investment. The key umbrella organization 102 commonly will not desire to make an investment in marketing of the tools of the service company 10. In some cases, a charter of the key umbrella organization 102 may even prohibit such marketing activities. It has been found that the service company 10 can act as a motivator to cause the key umbrella organization 102 to work with client organizations 16 to develop a need for the tools. The service company 10 provides a grant to the key umbrella organization 102 to develop a plan for implementation of the tools by client organizations 16. Efficiency in fund raising is facilitated because additional costs in reaching further populations of individuals are incremental.

The grant may be structured in several ways. The service company 10 may work out a plan with the key umbrella organization 102 and then provide the grant. The service company 10 and the key umbrella organization 102 may agree on a series of milestones. The service company 10 may provide progress payments at each milestone. The key umbrella organization 102 executes its plan. A number of different results are produced. One result includes a list of client organizations 16 that sign up to use the tools. Also, a population of client organizations 16 who use the tools is produced. Another result is a list of subscribing individuals 24 that opt to receive communications from client organizations 16. A further subgroup of individuals 24 will be contributors to a client organization 16. Further results include revenues to the service company 10, key umbrella organization 102 and client organizations 16.

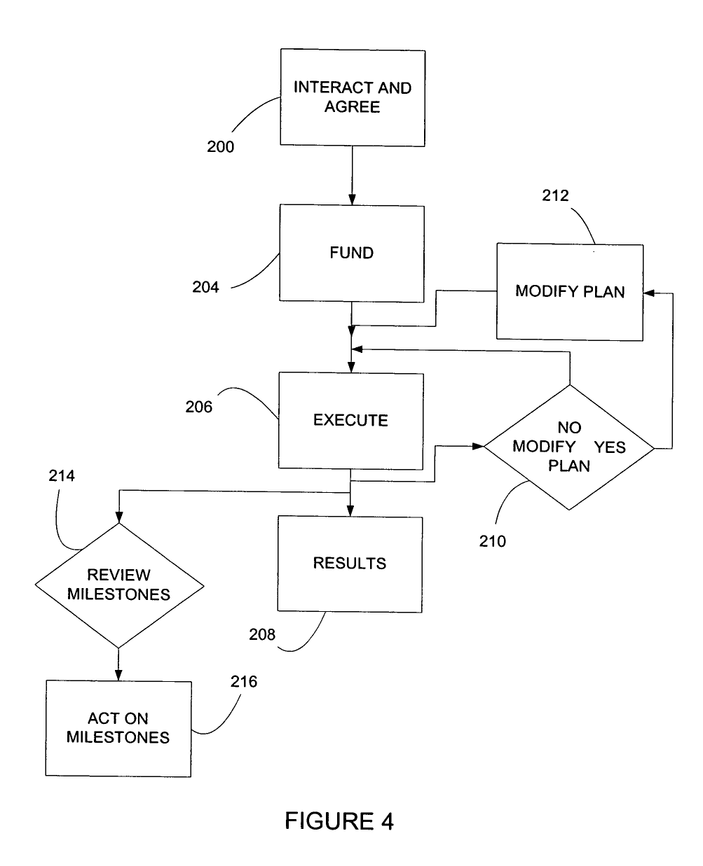

The method is further discussed with reference to FIG. 4. At block 200, the service company 10 and the key umbrella organization 102 interact with regard to produce of a plan of action in conjunction with the key umbrella organization 102 to produce measurable results (block 208). This leads to funding by the service company 10 of the key umbrella organization 102 at block 204. The key umbrella organization 102 executes at least some steps of the plan at block 206. Results are produced at block 208. The key umbrella organization 102 continues execution of the plan, illustrated by a return to block 206. The loop to return to block 206 includes a decision branch 210 at which it is decided if refinements are to be made to the plan. If so, refinements are made at block 212, and execution of the plan continues. Copywriting changes may be made. Additional support may be provided. If milestones are to be measured, a further branch from block 206 may lead to block 214 at which an evaluation is made. If milestones are met, action commensurate with the milestone is taken at block 216. This action may be payment by the service company 10 to the key umbrella organization 102.

Unexpected advantages are derived from the above-described methods. Embodiments of the present invention provide the ability to create processes that deal with life issues that are important to the individual. The individual is provided with customized content in communications. Also, for links which the individual accesses, the server may remember what the individual accessed in a previous session and provide next information in a sequence. Embodiments of the present invention encourage use of the tools to the maximum extent by client organizations to achieve the vision of each client organization. Efficiency in fund raising is facilitated because additional costs in reaching further populations of individuals are incremental. The key umbrella organization is encouraged to develop a program to get client organizations to utilize the tools. The system maintains respect for individuals by meeting their needs in providing selected content. Production of revenues is facilitated while needs of individuals and organizations are met. Many different forms of key umbrella organizations can utilize methods comprising embodiments of the present invention. In practice, the key umbrella organizations will have many different forms of official designations, e.g. “National Conference” or “Association.” Client organizations may have varying degrees of formality of affiliation with key umbrella organizations.

Embodiments of the invention can be varied in many ways. Such variations are not to be regarded as a departure from the spirit and scope of the invention, and all such modifications are intended to be within the scope of the invention.

What is claimed is:

1. A method of distributing relationship tools by a service company through at least one key umbrella organization, each said key umbrella organization having an affiliation with at least one client organization, said method comprising:
providing relationship software operated by the service company, the relationship software establishing relationships between subscribers and a client organization;
enrolling client organizations to each have the relationship software operated on its behalf;
enrolling client organizations by a key umbrella organization; and
providing a grant from the service company to the key umbrella organization to fund promotion by the key umbrella organization to the client organization.

2. A method according to claim 1 wherein said key umbrella organization addresses a portfolio of at least one thousand client organizations.

3. A method according to claim 2 wherein said key umbrella organization and the client organizations have an affinity relationship.

4. A method according to claim 3 further comprising generation of a marketing plan by said key umbrella organization.

5. A method of utilizing relationship software comprising:
providing hosted content accessible by individuals;
communicating to individuals and providing links to the hosted content;
enabling an individual to select in response options including a frequency of communication for further communication and at least one content options including content to indicate an interest of the individual; and
further communicating repeatedly with the individual in accordance with the options selected by the individual and including in the communication content to address the indicated interest that does not include promotional material.

6. A method according to claim 5 further comprising provided hosted content allowing the individual to contribute to an entity communicating with the individual.
